(19) United States
(12) Patent Application Publication
(10) Pub. No.: US 2026/0243060 A1
(43) Pub. Date: Aug. 20, 2026

(54) WORK MACHINE CONTROL SYSTEM, WORK MACHINE, AND WORK MACHINE CONTROL METHOD

(71) Applicant: KOMATSU LTD., Tokyo (JP)

(72) Inventors: Hiromasa KITAMURA, Tokyo (JP); Yoshihiro KUMAGAE, Tokyo (JP); Yuta TANIGUCHI, Tokyo (JP); Kentaro MURAKAMI, Tokyo (JP)

(73) Assignee: KOMATSU LTD., Tokyo (JP)

(21) Appl. No.: 19/121,430

(22) PCT Filed: Oct. 19, 2023
(86) PCT No.: PCT/JP2023/037817

§ 371 Date: Apr. 16, 2025

(30) Foreign Application Priority Data
Oct. 21, 2022 (JP) 2022-168958

(51) Int. Cl. E02F 9/20; E02F 9/22

(52) U.S. Cl. CPC E02F 9/2095; E02F 9/226

(57) ABSTRACT

A control system for a work machine includes a key switch that is operated to be in one operation state of a key-off state, a key-on state, and a key-start state, an electric fan that generates an airflow for cooling an object to be cooled that is part of a work machine, and a controller that maintains the electric fan in a predetermined state in the key-on state.

### TECHNICAL FIELD

The disclosure relates to a work machine control system, a work machine, and a work machine control method.

### BACKGROUND ART

In a technical field related to a work machine, a construction machine is known that is equipped with an electric fan that blows air to cool a battery device, as disclosed in Patent Document 1.

### CITATION LIST

### Patent Literature

Patent Document 1: JP 2020-051065 A

### SUMMARY OF INVENTION

### Technical Problem

An inspector may inspect or service a work machine in a key-on state of the work machine. During inspection or service of the work machine, for example, if an electric fan suddenly starts running while the inspector is near the electric fan, the workability of the inspection or maintenance may deteriorate.

An object of the disclosure is to suppress the deterioration in the workability of the inspection or maintenance of a work machine.

### Solution to Problem

According to the disclosure, there is provided a control system for a work machine including a key switch configured to be in one operation state of a key-off state, a key-on state, and a key-start state by being operated, an electric fan configured to generate an airflow for cooling an object to be cooled that is part of the work machine, and a controller configured to maintain the electric fan in a predetermined state in the key-on state.

### Advantageous Effects of Invention

According to the disclosure, the deterioration in the workability of the maintenance or inspection of a work machine is suppressed.

### BRIEF DESCRIPTION OF DRAWINGS

FIG. 1 is a diagram schematically illustrating a work machine according to an embodiment.

FIG. 2 is a block diagram illustrating the work machine according to the embodiment.

FIG. 3 is a block diagram illustrating a control system of the work machine according to the embodiment.

FIG. 4 is a block diagram illustrating a controller according to the embodiment.

FIG. 5 is a flowchart illustrating a first example of a control method of the work machine according to the embodiment.

FIG. 6 is a flowchart illustrating a second example of the control method of the work machine according to the embodiment.

### DESCRIPTION OF EMBODIMENTS

Hereinafter, embodiments of the disclosure will be described, but the disclosure is not limited to the embodiments. Components of the embodiments described below can be combined as appropriate. In addition, some components may not be used in some cases.

### Work Machine

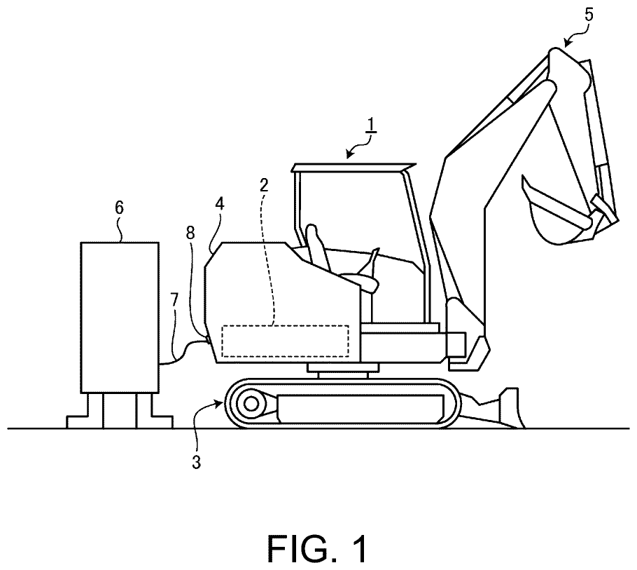

FIG. 1 is a diagram schematically illustrating a work machine 1 according to an embodiment. In the embodiment, the work machine 1 is an electric work machine that uses a battery 2 as a drive source. The battery 2 is mounted on the work machine 1. In the embodiment, the work machine 1 is an electric shovel. The work machine 1 includes a lower traveling body 3 including a crawler belt, an upper swing body 4 supported by the lower traveling body 3, and a work implement 5 supported by the upper swing body 4. The work implement 5 includes a boom coupled to the upper swing body 4, an arm coupled to the boom, and a bucket coupled to the arm.

The battery 2 includes a secondary battery. At a site where the work machine 1 works, the battery 2 is charged by a charging device 6. In the embodiment, the battery 2 includes a rechargeable lithium-ion battery. The charging device 6 is connected to the work machine 1 via a cable 7. The work machine 1 is provided with a charging port 8. The cable 7 is attached to and detached from the charging port 8. Power output from the charging device 6 is input to the battery 2 via the cable 7 and the charging port 8. The battery 2 is charged by the power output from the charging device 6.

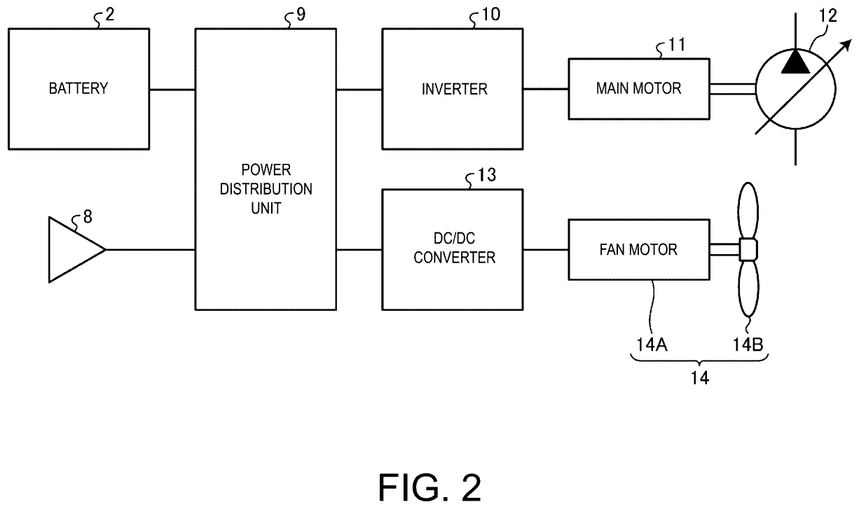

FIG. 2 is a block diagram illustrating the work machine 1 according to the embodiment. The work machine 1 includes the battery 2, the charging port 8, a power distribution unit 9, an inverter 10, a main motor 11, a hydraulic pump 12, a DC/DC converter 13, and an electric fan 14.

The power distribution unit 9 (PDU) distributes power from the battery 2. The inverter 10 supplies power from the power distribution unit 9 to the main motor 11. The inverter 10 converts a DC voltage output from the power distribution unit 9 into an AC voltage and outputs the AC voltage to the main motor 11. The main motor 11 is an electric motor. The main motor 11 is driven by the power from the inverter 10. The hydraulic pump 12 is driven by the main motor 11. The hydraulic pump 12 discharges hydraulic oil. The hydraulic oil discharged from the hydraulic pump 12 is supplied to a hydraulic actuator of the work machine 1. The hydraulic actuator of the work machine 1 includes a traveling hydraulic motor that rotates the crawler belt of the lower traveling body 3, a swing hydraulic motor that swings the upper swing body 4, and a hydraulic cylinder that operates the work implement 5.

The DC/DC converter 13 converts a voltage of the battery 2 output from the power distribution unit 9 to a predetermined voltage. In the embodiment, the DC/DC converter 13 steps down the voltage of the battery 2 at a predetermined step-down ratio. The electric fan 14 is driven based on a power output from the DC/DC converter 13. The electric fan 14 generates an airflow for cooling an object to be cooled that is part of the work machine 1. In the embodiment, the battery 2, the inverter 10, the main motor 11, and the DC/DC converter 13 are each cooled by a liquid-cooled heat exchanger. The liquid-cooled heat exchanger may be a water-cooled heat exchanger or an oil-cooled heat exchanger. The object to be cooled includes the liquid-cooled heat exchanger for cooling the battery 2, the inverter 10, the main motor 11, and the DC/DC converter 13. The battery 2, the inverter 10, the main motor 11, and the DC/DC converter 13 may each be cooled by a water-cooled heat exchanger (radiator). The electric fan 14 generates an airflow for cooling the liquid-cooled heat exchanger. The electric fan 14 includes a fan motor 14A and a fan 14B that is rotated by rotational force generated by the fan motor 14A. The fan motor 14A is an electric motor.

### Control System

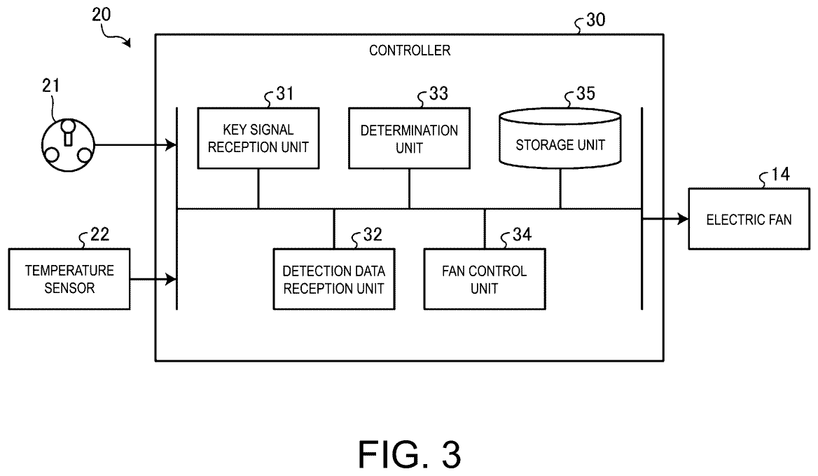

FIG. 3 is a block diagram illustrating a control system 20 of the work machine 1 according to the embodiment. The control system 20 includes a key switch 21, a temperature sensor 22, the electric fan 14, and a controller 30.

The key switch 21 is operated by an operator so as to be in one operation state of a key-off state, a key-on state, and a key-start state. When the operator turns the key while the key is inserted into a key cylinder, the key switch 21 turns to one of “off”, “on”, and “start” positions. When the key is turned to the “off” position, the key switch 21 is in the key-off state. When the key is turned to the “on” position, the key switch 21 is in the key-on state. When the key is turned to the “start” position, the key switch 21 is in the key-start state.

The key switch 21 outputs a key signal to the controller 30. Key signals output from the key switch 21 include a key-off signal that is output in the key-off state, a key-on signal that is output in the key-on state, and a key-start signal that is output in the key-start state.

When the key switch 21 is in the key-off state, power is not supplied to either the controller 30 or the electric fan 14. When the key switch 21 is in the key-off state, the main motor 11 cannot be driven. When the key switch 21 is in the key-on state, power is supplied to both the controller 30 and the electric fan 14. When the key switch 21 is in the key-on state, the main motor 11 cannot start driving. When the key switch 21 is in the key-start state, power is supplied to both the controller 30 and the electric fan 14. When the key switch 21 is in the key-start state, the main motor 11 starts driving. In the key-start state, the controller 30 drives the main motor 11 by outputting a control command to the inverter 10. The control commands output to the inverter 10 include a voltage command and a current upper limit value command to be input to the main motor 11. In the key-on state or the key-start state, the controller 30 outputs a control command to the DC/DC converter 13 to drive the electric fan 14. The control commands output to the DC/DC converter 13 include a target rotation speed command for the fan 14B, and a voltage command and a current upper limit value command to be input to the fan motor 14A.

The temperature sensor 22 detects a temperature of the object to be cooled. As described above, components of the work machine 1, such as the battery 2, the inverter 10, the main motor 11, and the DC/DC converter 13, are cooled by the liquid-cooled heat exchanger. In the embodiment, the temperature sensor 22 detects a temperature of coolant in the liquid-cooled heat exchanger. Detection data of the temperature sensor 22 is transmitted from the temperature sensor 22 to the controller 30.

The controller 30 operates based on power supplied from the battery 2. The controller 30 maintains the electric fan 14 in a predetermined state in the key-on state. The predetermined state is a driven state or a stopped state. The driven state means that the fan 14B is in a rotation state. Rotation states of the fan 14B include a constant speed rotation state in which the fan 14B rotates at a rotation speed determined not based on the temperature of the object to be cooled, and a variable rotation state in which the fan 14B rotates at a rotation speed determined based on the temperature of the object to be cooled. The rotation speed of the fan 14B in the constant speed rotation state is preferably a low rotation speed. The controller 30 can maintain the electric fan 14 in the driven state in the key-on state. The controller 30 can maintain the electric fan 14 in the stopped state in the key-on state.

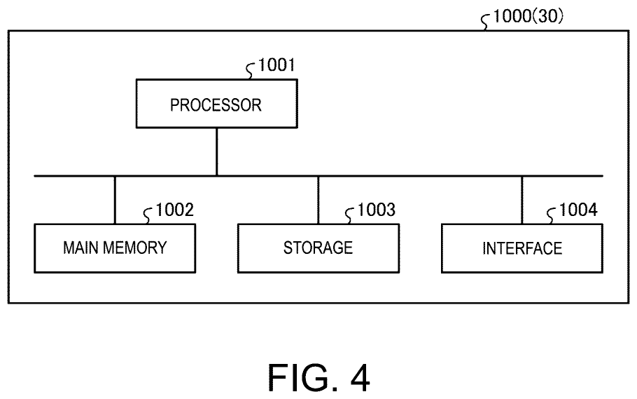

FIG. 4 is a block diagram illustrating the controller 30 according to the embodiment. The controller 30 includes a computer system 1000. The computer system 1000 includes a processor 1001 such as a central processing unit (CPU), a main memory 1002 including a non-volatile memory such as a read only memory (ROM) and a volatile memory such as a random access memory (RAM), a storage 1003, and an interface 1004 including an input/output circuit. Functions of the controller 30 are stored in the storage 1003 as a computer program. The processor 1001 reads out the computer program from the storage 1003, loads the computer program into the main memory 1002, and executes the above-described processing in accordance with the program. The computer program may be distributed to the computer system 1000 via a network.

As illustrated in FIG. 3, the controller 30 includes a key signal reception unit 31, a detection data reception unit 32, a determination unit 33, a fan control unit 34, and a storage unit 35. Note that the key signal reception unit 31, the detection data reception unit 32, the determination unit 33, the fan control unit 34, and the storage unit 35 may be configured as separate hardware (controllers).

The key signal reception unit 31 receives a key signal from the key switch 21. Key signals include a key-off signal, a key-on signal, and a key-start signal. The detection data reception unit 32 receives detection data from the temperature sensor 22. The detection data of the temperature sensor 22 indicates the temperature of the object to be cooled.

The determination unit 33 determines whether the key signal received by the key signal reception unit 31 is the key-off signal, the key-on signal, or the key-start signal. The determination unit 33 determines whether the operation state of the key switch 21 is the key-off state, the key-on state, or the key-start state based on the key signal received by the key signal reception unit 31.

The fan control unit 34 outputs a control command for controlling the electric fan 14 based on the operation state of the key switch 21 determined by the determination unit 33. In the embodiment, the fan control unit 34 controls the electric fan 14 by controlling the DC/DC converter 13. The control of the electric fan 14 includes driving the electric fan 14, stopping the electric fan 14, and adjusting the rotation speed of the electric fan 14. Driving the electric fan 14 means driving the fan motor 14A. Stopping the electric fan 14 means stopping the fan motor 14A. Adjusting the rotation speed of the electric fan 14 includes adjusting the rotation speed of the fan motor 14A.

The storage unit 35 stores correlation data representing a relationship between the temperature of the object to be cooled and the rotation speed of the electric fan 14. The correlation data is predetermined. The correlation data is determined such that the lower the temperature of the object to be cooled, the lower the rotation speed of the electric fan 14, and the higher the temperature of the object to be cooled, the higher the rotation speed of the electric fan 14.

### First Example of Control Method

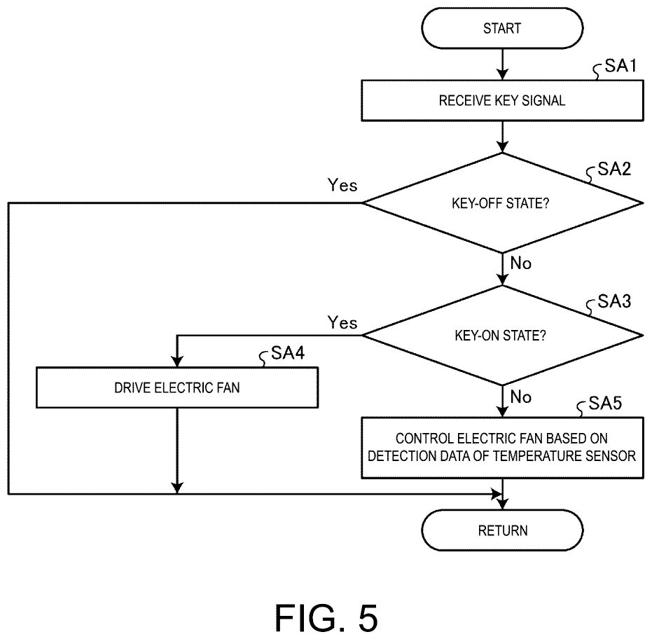

FIG. 5 is a flowchart illustrating a first example of a control method of the work machine 1 according to the embodiment. FIG. 5 illustrates an example in which the electric fan 14 is maintained in the rotation state in the key-on state.

The key signal reception unit 31 receives a key signal (step SA1). The determination unit 33 determines whether the operation state of the key switch 21 is the key-off state based on the key signal received by the key signal reception unit 31 (step SA2). If it is determined in step SA2 that the operation state of the key switch 21 is the key-off state (step SA2: Yes), the electric fan 14 is not driven and the process returns to step SA1.

If it is determined in step SA2 that the operation state of the key switch 21 is not the key-off state (step SA2: No), the determination unit 33 determines whether the operation state of the key switch 21 is the key-on state (step SA3).

If it is determined in step SA3 that the operation state of the key switch 21 is the key-on state (step SA3: Yes), the fan control unit 34 drives the electric fan 14 (step SA4). The fan control unit 34 maintains the electric fan 14 in the driven state when the operation state of the key switch 21 is the key-on state. The fan control unit 34 continues to drive the electric fan 14 while the operation state of the key switch 21 is the key-on state. Putting the electric fan 14 in the driven state includes rotating the electric fan 14 at a low rotation speed. The rotation speed of the electric fan 14 may be a rotation speed at which an inspector can recognize that the electric fan 14 is in the driven state. By rotating the electric fan 14 at a low rotation speed, power consumption is reduced and generation of noise is suppressed.

When the operation state of the key switch 21 is the key-on state, the fan control unit 34 may adjust the rotation speed of the electric fan 14 based on the detection data of the temperature sensor 22 received by the detection data reception unit 32. For example, the fan control unit 34 may control the electric fan 14 based on the detection data of the temperature sensor 22 and the correlation data stored in the storage unit 35 such that the lower the temperature of the object to be cooled, the lower the rotation speed of the electric fan 14, and the higher the temperature of the object to be cooled, the higher the rotation speed of the electric fan 14.

If it is determined in step SA3 that the operation state of the key switch 21 is not the key-on state (step SA3: No), the determination unit 33 determines that the operation state of the key switch 21 is the key-start state. When the operation state of the key switch 21 is the key-start state, the main motor 11 starts driving. When the operation state of the key switch 21 is the key-start state, the fan control unit 34 controls the electric fan 14 based on the detection data of the temperature sensor 22 received by the detection reception unit 32 (step SA5). When the temperature of the object to be cooled detected by the temperature sensor 22 is lower than a predetermined temperature threshold, the fan control unit 34 rotates the electric fan 14 at a rotation speed lower than a predetermined rotation speed. When the temperature of the object to be cooled detected by the temperature sensor 22 is equal to or higher than the temperature threshold, the fan control unit 34 rotates the electric fan 14 at a rotation speed higher than the predetermined rotation speed. When the temperature of the object to be cooled detected by the temperature sensor 22 is equal to or higher than the temperature threshold, the fan control unit 34 may adjust the rotation speed of the electric fan 14 based on the detection data of the temperature sensor 22 received by the detection data reception unit 32. For example, the fan control unit 34 may control the electric fan 14 based on the detection data of the temperature sensor 22 and the correlation data stored in the storage unit 35 such that the lower the temperature of the object to be cooled, the lower the rotation speed of the electric fan 14, and the higher the temperature of the object to be cooled, the higher the rotation speed of the electric fan 14.

### Second Example of Control Method

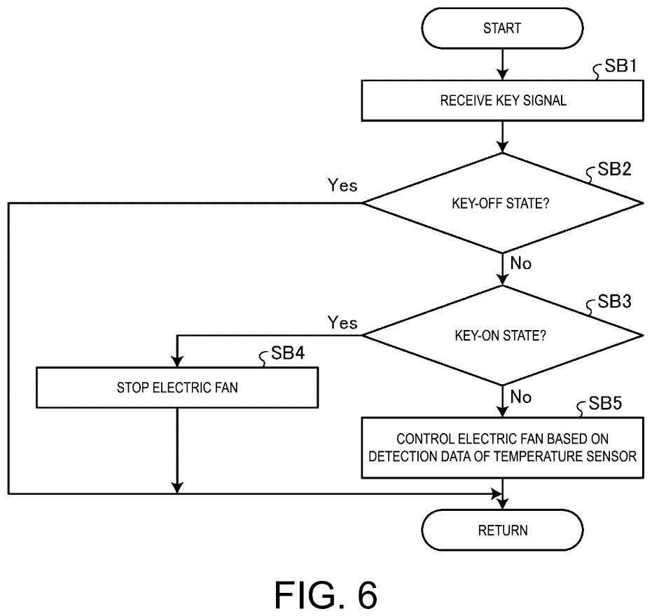

FIG. 6 is a flowchart illustrating a second example of the control method of the work machine 1 according to the embodiment. FIG. 6 illustrates an example in which the electric fan 14 is maintained in a stopped state in the key-on state.

The key signal reception unit 31 receives a key signal (step SB1). The determination unit 33 determines whether the operation state of the key switch 21 is the key-off state based on the key signal received by the key signal reception unit 31 (step SB2). If it is determined in step SB2 that the operation state of the key switch 21 is the key-off state (step SB2: Yes), the electric fan 14 is not driven and the process returns to step SB1.

If it is determined in step SB2 that the operation state of the key switch 21 is not the key-off state (step SB2: No), the determination unit 33 determines whether the operation state of the key switch 21 is the key-on state (step SB3).

If it is determined in step SB3 that the operation state of the key switch 21 is the key-on state (step SB3: Yes), the fan control unit 34 does not drive the electric fan 14 (step SB4). The fan control unit 34 maintains the electric fan 14 in the stopped state when the operation state of the key switch 21 is the key-on state. The fan control unit 34 continues to stop the electric fan 14 while the operation state of the key switch 21 is the key-on state. The fan control unit 34 prohibits driving of the electric fan 14 while the operation state of the key switch 21 is the key-on state.

If it is determined in step SB3 that the operation state of the key switch 21 is not the key-on state (step SB3: No), the determination unit 33 determines that the operation state of the key switch 21 is the key-start state. When the operation state of the key switch 21 is the key-start state, the main motor 11 starts driving. When the operation state of the key switch 21 is the key-start state, the fan control unit 34 controls the electric fan 14 based on the detection data of the temperature sensor 22 received by the detection reception unit 32 (step SB5). When the temperature of the object to be cooled detected by the temperature sensor 22 is lower than a predetermined temperature threshold, the fan control unit 34 rotates the electric fan 14 at a rotation speed lower than a predetermined rotation speed. When the temperature of the object to be cooled detected by the temperature sensor 22 is equal to or higher than the temperature threshold, the fan control unit 34 rotates the electric fan 14 at a rotation speed higher than the predetermined rotation speed. When the temperature of the object to be cooled detected by the temperature sensor 22 is equal to or higher than the temperature threshold, the fan control unit 34 may adjust the rotation speed of the electric fan 14 based on the detection data of the temperature sensor 22 received by the detection data reception unit 32. For example, the fan control unit 34 may control the electric fan 14 based on the detection data of the temperature sensor 22 and the correlation data stored in the storage unit 35 such that the lower the temperature of the object to be cooled, the lower the rotation speed of the electric fan 14, and the higher the temperature of the object to be cooled 1, the higher the rotation speed of the electric fan 14.

### Effects

As described above, the work machine 1 includes the key switch 21 that is operated to be in one operation state of the key-off state, the key-on state, and the key-start state, the electric fan 14 that generates an airflow for cooling the object to be cooled that is part of the work machine 1, and the controller 30 that maintains the electric fan 14 in a predetermined state in the key-on state.

According to the embodiment, when an inspector inspects or services the work machine 1 in the key-on state, the electric fan 14 is maintained in the driven state or the stopped state. The operation of the electric fan 14 is not determined based on the temperature of the object to be cooled, but determined based on the operation state of the key switch 21. Accordingly, the deterioration in the workability of inspection or maintenance is suppressed. When the electric fan 14 continues to drive while the work machine 1 is in the key-on state, an inspector can efficiently perform inspection or service work while staying away from the electric fan 14. When the electric fan 14 continues to be stopped while the work machine 1 is in the key-on state, the electric fan 14 does not suddenly start driving when an inspector is near the electric fan 14, allowing the inspector to efficiently perform inspection or service work.

When the electric fan 14 is maintained in the rotation state while the work machine 1 is in the key-on state, the fan control unit 34 can set the rotation speed of the electric fan 14 as desired. For example, by rotating the electric fan 14 at a low rotation speed when the work machine 1 is in the key-on state, generation of noise can be suppressed. In addition, by rotating the electric fan 14 at a low rotation speed, the power consumption of the electric fan 14 can be reduced. Further, as described with reference to FIG. 5, by adjusting the rotation speed of the electric fan 14 based on the temperature of the object to be cooled when the work machine 1 is in the key-on state, the object to be cooled can be appropriately cooled even when the work machine 1 is in the key-on state.

When the electric fan 14 is maintained in the stopped state while the work machine 1 is in the key-on state, generation of noise can be suppressed. Further, when the work machine 1 is in the key-on state, the driving of the electric fan 14 is prohibited, so that an inspector can efficiently perform inspection or service work on the work machine 1.

### Other Embodiments

In the above-described embodiment, the object to be cooled by the electric fan 14 is the coolant in the liquid-cooled heat exchanger. The liquid-cooled heat exchanger may be a water-cooled heat exchanger (radiator) or an oil-cooled heat exchanger (oil cooler). When the liquid-cooled heat exchanger is a radiator, the object to be cooled by the electric fan 14 is cooling water in the radiator. The components of the work machine 1 that are cooled by the liquid-cooled heat exchanger are not limited to the battery 2, the inverter 10, the main motor 11, and the DC/DC converter 13. When the liquid-cooled heat exchanger is an oil cooler, the oil cooler may cool hydraulic oil of a hydraulic system of the work machine 1.

When multiple objects to be cooled exist, the controller 30 may drive the electric fan 14 at the maximum rotation speed of the electric fan 14 determined based on the respective temperatures of the multiple objects to be cooled. For example, when a radiator, an oil cooler, and an air conditioner condenser are mounted on the work machine 1 as objects to be cooled, correlation data representing relationships between the temperatures of the multiple objects to be cooled and the respective rotation speeds of the electric fan 14 may be stored in the storage unit 35. The correlation data may be determined such that the lower the temperature of the object to be cooled, the lower the rotation speed of the electric fan 14, and the higher the temperature of the object to be cooled, the higher the rotation speed of the electric fan 14. Based on the temperatures of the objects to be cooled and the correlation data, the rotation speed of the electric fan 14 for cooling the radiator is determined to be a first rotation speed, the rotation speed of the electric fan 14 for cooling the oil cooler is determined to be a second rotation speed, and the rotation speed of the electric fan 14 for cooling the condenser is determined to be a third rotation speed, and for example, when the first rotation speed is higher than the second rotation speed and the third rotation speed, the controller 30 may drive the electric fan 14 at the first rotation speed.

In the above-described embodiment, the work machine 1 is an electric shovel. The work machine 1 may be, for example, an electric forklift.

In the above-described embodiment, the drive source of the work machine 1 is the main motor 11. That is, the work machine 1 is an electric work machine. The drive source of the work machine 1 may be an engine. The object to be cooled by the electric fan 14 may be an engine or a radiator that cools the engine.

### Reference Signs List

1 Work machine, 2 Battery, 3 Lower traveling body, 4 Upper swing body, 5 Work implement, 6 Charging device, 7 Cable, 8 Charging port, 9 Power distribution unit, 10 Inverter, 11 Main motor, 12 Hydraulic pump, 13 DC/DC converter, 14 Electric fan, 14A Fan motor, 14B Fan, 20 Control system, 21 Key switch, 22 Temperature sensor, 30 Controller, 31 Key signal reception unit, 32 Detection data reception unit, 33 Determination unit, 34 Fan control unit, 35 Storage unit, 1000 Computer system, 1001 Processor, 1002 Main memory, 1003 Storage, 1004 Interface.

1. A control system for a work machine comprising:
a key switch configured to be in one operation state of a key-off state, a key-on state, and a key-start state by being operated;
an electric fan configured to generate an airflow for cooling an object to be cooled that is part of a work machine; and
a controller configured to maintain the electric fan in a predetermined state in the key-on state.

2. The control system for a work machine according to claim 1, wherein
the controller maintains the electric fan in a driven state in the key-on state.

3. The control system for a work machine according to claim 2, comprising:
a temperature sensor configured to detect a temperature of the object to be cooled, wherein
the controller adjusts a rotation speed of the electric fan based on detection data of the temperature sensor in the key-on state.

4. The control system for a work machine according to claim 1, wherein
the controller maintains the electric fan in a stopped state in the key-on state.

5. The control system for a work machine according to claim 2, comprising:
a temperature sensor configured to detect a temperature of the object to be cooled, wherein
in the key-start state, when a temperature of the object to be cooled detected by the temperature sensor is lower than a temperature threshold, the controller stops the electric fan, and when the temperature of the object to be cooled is equal to or higher than the temperature threshold, the controller drives the electric fan.

6. The control system for a work machine according to claim 5, wherein
the work machine includes an electric motor and a hydraulic pump driven by the electric motor, and
the object to be cooled includes the electric motor.

7. A work machine comprising:
the control system for a work machine according to claim 1.

8. A control method for a work machine comprising:
acquiring an operation state of a key switch, the key switch being in one operation state of a key-off state, a key-on state, and a key-start state by being operated; and
maintaining, in the key-on state, an electric fan in a predetermined state, the electric fan generating an airflow for cooling an object to be cooled that is part of a work machine.
